(19) United States
(12) Patent Application Publication
(10) Pub. No.: US 2026/0104311 A1
(43) Pub. Date: Apr. 16, 2026

(54) DIAGNOSTIC DEVICE, IMAGING DEVICE, DIAGNOSTIC DATA GENERATION METHOD, AND DIAGNOSTIC PROGRAM

(71) Applicant: DENSO CORPORATION, Kariya-city (JP)

(72) Inventors: SAKITO MIKI, Kariya-city (JP); TEIYU KIMURA, Kariya-city (JP)

(21) Appl. No.: 19/419,990

(22) Filed: Dec. 15, 2025

Related U.S. Application Data
(63) Continuation of application No. PCT/JP2024/018614, filed on May 21, 2024.

(30) Foreign Application Priority Data
Jun. 28, 2023 (JP) 2023-106119

(51) Int. Cl. G01M 11/02

(52) U.S. Cl. CPC G01M 11/0207

(57) ABSTRACT

A diagnostic data generating method includes obtaining an internal reflection intensity by receiving an internal reflection beam, which is reflected on an inner surface of a light-transmitting panel, with an imaging element at an internal reflection receiving position, obtaining an external reflection intensity by receiving an external reflection beam, which is reflected on an outer surface of the light-transmitting panel, with the imaging element at an external reflection receiving position, and generating the diagnostic data indicating a degradation state of the outer surface on which a light-transmitting coating layer is disposed, which is determined based on a relative intensity ratio between the internal reflection intensity and the external reflection intensity.

### CROSS REFERENCE TO RELATED APPLICATION

The present application is a continuation application of International Patent Application No. PCT/JP2024/018614 filed on May 21, 2024, which designated the U.S. and claims the benefit of priority from Japanese Patent Application No. 2023-106119 filed on Jun. 28, 2023. The entire disclosures of all the above applications are incorporated herein by reference.

### TECHNICAL FIELD

The present disclosure relates to a technology for diagnosing an imaging device that optically captures images of an external space.

### BACKGROUND ART

There is a technology that optically captures images of an external space from an internal space by an image sensor, through a camera cover that separates the external space from the internal space.

### SUMMARY

According to a first aspect of the present disclosure, a diagnostic device configured to diagnose an imaging device disposed in an internal space that is separated from an external space by a light-transmitting panel is provided. The imaging device optically images the external space with an imaging element through the light-transmitting panel. The diagnostic device includes a processor. The processor may be configured to obtain an internal reflection intensity by receiving an internal reflection beam with the imaging element at an internal reflection receiving position. The internal reflection beam is a reflection of a diagnostic beam, which is emitted from a fixed point in the internal space, reflected on an inner surface of the light-transmitting panel that faces the internal space. The processor may be configured to obtain an external reflection intensity by receiving an external reflection beam with the imaging element at an external reflection receiving position. The external reflection beam is a reflection of the diagnostic beam reflected on an outer surface of the light-transmitting panel that faces the external space. The processor may be configured to generate diagnostic data indicating a degradation state of the outer surface on which a light-transmitting coating layer is disposed. The degradation state may be determined based on a relative intensity ratio between the internal reflection intensity and the external reflection intensity.

### BRIEF DESCRIPTION OF DRAWINGS

FIG. 1 is a cross-sectional view showing the physical configuration of an embodiment.

FIG. 2 is a schematic diagram showing the planar configuration of the imaging element according to an embodiment.

FIG. 3 is a schematic diagram showing light-receiving characteristics according to an embodiment, corresponding to the cross-sectional view of FIG. 1.

FIG. 4 is a schematic diagram for explaining a light-receiving state of a reflected beam in the imaging element according to an embodiment.

FIG. 5 is a block diagram showing the functional configuration of a diagnostic device according to an embodiment.

FIG. 6 is a flowchart showing a diagnostic flow according to an embodiment.

### DESCRIPTION OF EMBODIMENTS

To begin with, examples of relevant techniques will be described.

There is a technology that optically captures images of an external space from an internal space by an image sensor, through a camera cover that separates the external space from the internal space. In this technology, a hydrophilic coating layer is provided on the outer surface of the camera cover to prevent water droplets and dirt from adhering to the camera cover.

However, the technology described above has difficulty detecting a deterioration of the hydrophilic coating layer on the outer surface of the camera cover, even if the imaging accuracy decreases due to the deterioration.

The present disclosure provides a diagnostic device, a diagnostic data generation method, and a diagnostic program for diagnosing a decrease in imaging accuracy in an imaging device. The present disclosure also provides an imaging device equipped with a diagnostic device for diagnosing a decrease in imaging accuracy.

Hereinafter, the technical means of the present disclosure for solving the above problems will be described.

According to a first aspect of the present disclosure, a diagnostic device configured to diagnose an imaging device disposed in an internal space that is separated from an external space by a light-transmitting panel is provided. The imaging device optically images the external space with an imaging element through the light-transmitting panel. The diagnostic device includes a processor. The processor is configured to obtain an internal reflection intensity by receiving an internal reflection beam with the imaging element at an internal reflection receiving position. The internal reflection beam is a reflection of a diagnostic beam, which is emitted from a fixed point in the internal space, reflected on an inner surface of the light-transmitting panel that faces the internal space. The processor is configured to obtain an external reflection intensity by receiving an external reflection beam with the imaging element at an external reflection receiving position. The external reflection beam is a reflection of the diagnostic beam reflected on an outer surface of the light-transmitting panel that faces the external space. The processor is configured to generate diagnostic data indicating a degradation state of the outer surface on which a light-transmitting coating layer is disposed. The degradation state is determined based on a relative intensity ratio between the internal reflection intensity and the external reflection intensity.

According to a second aspect of the present disclosure, an imaging device configured to image an external space with an imaging element from an internal space through a light-transmitting element that separates the internal space from the external space is provided. The imaging device includes the imaging element, a light source configured to emit a diagnostic beam from a fixed point in the internal space, and the diagnostic device according to the first aspect.

According to a third aspect of the present disclosure, a diagnostic data generating method executed by a processor to generate diagnostic data indicating a diagnosis of an imaging device is provided. The imaging device optically images an external space from an internal space with an imaging element through a light-transmitting panel that separates the internal space from the external space. The method includes obtaining an internal reflection intensity by receiving an internal reflection beam with the imaging element at an internal reflection receiving position. The internal reflection beam is a reflection of a diagnostic beam, which is emitted from a fixed point in the internal space, reflected on an inner surface of the light-transmitting panel that faces the internal space. The method further includes obtaining an external reflection intensity by receiving an external reflection beam with the imaging element at an external reflection receiving position. The external reflection beam is a reflection of the diagnostic beam reflected on an outer surface of the light-transmitting panel that faces the external space. The method further includes generating the diagnostic data indicating a degradation state of the outer surface on which a light-transmitting coating layer is disposed. The degradation state is determined based on a relative intensity ratio between the internal reflection intensity and the external reflection intensity.

According to a fourth aspect of the present disclosure, a diagnostic program that is stored in a memory to diagnose an imaging device that optically images an external space from an internal space with an imaging element through a light-transmitting panel that separates the internal space from the external space. The diagnostic program includes instructions configured to, when executed by a processor, cause the processor to obtain an internal reflection intensity by receiving an internal reflection beam with the imaging element at an internal reflection receiving position. The internal reflection beam is a reflection of a diagnostic beam, which is emitted from a fixed point in the internal space, reflected on an inner surface of the light-transmitting panel that faces the internal space. The program further causes the processor to obtain an external reflection intensity by receiving an external reflection beam with the imaging element at an external reflection receiving position. The external reflection beam is a reflection of the diagnostic beam reflected on an outer surface of the light-transmitting panel that faces the external space. The program further causes the processor to generate diagnostic data indicating a degradation state of the outer surface on which a light-transmitting coating layer is disposed. The degradation state is determined based on a relative intensity ratio between the internal reflection intensity and the external reflection intensity.

According to the first to fourth aspects, the internal reflection beam at the inner surface of the light-transmitting panel, as a reflection of a diagnostic beam that is emitted from a fixed light emission point in the internal space, is received by the imaging element at the internal reflection receiving position, thereby obtaining the internal reflection intensity at the panel inner surface. At the same time, the external reflection beam at the outer surface of the light-transmitting panel, as a reflection of the diagnostic beam, is received by the imaging element at the external reflection receiving position, thereby obtaining the external reflection intensity at the panel outer surface.

The diagnostic data according to the first to fourth aspects is generated to indicate a deterioration state that depends on the relative intensity ratio between the internal reflection intensity and the external reflection intensity, as a state of the panel outer surface provided with a light-transmitting coating layer. According to this, when deterioration occurs in the coating layer on the panel outer surface in the external space, changes in the external reflection intensity caused by the deterioration of the outer coating layer is reflected in the relative intensity ratio, since the internal reflection intensity at the panel inner surface, where deterioration is suppressed in the internal space, tends to remain stable. At this time, fluctuations in the intensity of the diagnostic beam itself can be offset in the relative intensity ratio. From these points, it is possible to diagnose a decrease in imaging accuracy of the imaging device caused by deterioration of the outer coating layer, based on the deterioration state indicated by the diagnostic data.

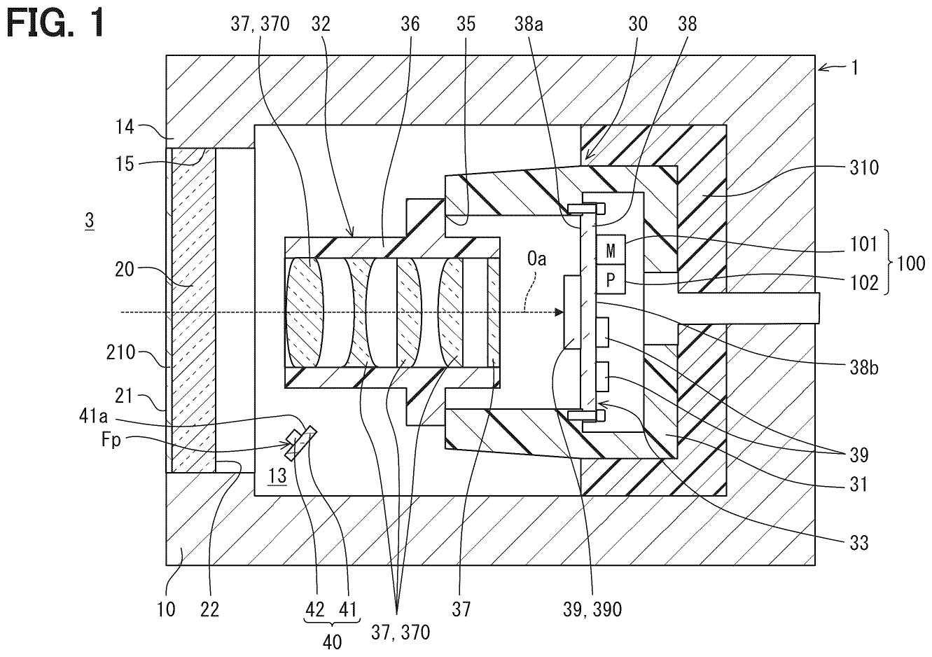

As shown in FIG. 1, an imaging device 1 to which a diagnostic device 100 according to one embodiment of the present disclosure is applied optically images an external space 3 of a vehicle. The imaging device 1 is mounted, for example, in an automobile which is capable of at least one type of operation among manual driving, autonomous driving, and remote driving. In the following description, unless otherwise specified, the directions of front, rear, upper, lower, left, and right are defined based on a vehicle on a horizontal plane. In addition, the horizontal direction and the vertical direction respectively refer to the directions parallel and perpendicular to the horizontal plane of the vehicle on the horizontal plane.

The imaging device 1 is disposed at at least one location of the vehicle among a front part, a left part, a right part, a rear part, and an upper roof. The imaging device 1 performs imaging processing on an optical image (hereinafter referred to as a target optical image) received from a target within an imaging area of the external space 3. The imaging area corresponds to an installation position of the imaging device 1 on the vehicle. Representative targets to be imaged by the imaging device 1 applied to a vehicle may include at least one type of moving objects, such as a pedestrian, cyclist, an animal other than a human, and another vehicle. Representative targets to be imaged by the imaging device 1 applied to a vehicle may include at least one type of stationary objects, such as a guardrail, road sign, roadside structure, and fallen object on the road.

The imaging device 1 includes a casing 10, a light-transmitting panel 20, a camera unit 30, a light source unit 40, and the diagnostic device 100. The casing 10 is formed as a generally hollow structure, mainly formed of multiple metallic base materials such as aluminum. The outer surface of the casing 10 is exposed to an outside air in the external space 3. The inner surface of the casing 10 encloses an internal space 13 as a closed space, sealing the internal space 13 off from the external space 3. The casing 10 has a vertical wall 14 along a horizontal direction and a vertical direction. The vertical wall 14 defines an optical opening 15, which penetrates between the outer and inner surfaces of the casing 10.

The light-transmitting panel 20 is formed in an overall flat plate shape, mainly formed of a light-transmitting base material such as synthetic resin or glass. The light-transmitting panel 20 is fitted and mounted to the vertical wall 14 of the casing 10, which surrounds the optical opening 15, via at least one of an adhesive and a sealing material, for example. The light-transmitting panel 20 covers the optical opening 15 to allow light to pass from the external space 3 to the internal space 13.

The light-transmitting panel 20 has a flat panel outer surface 21 that faces the external space 3 and is exposed to the outside air in the external space 3. The panel outer surface 21 functions as an incident surface for the target optical image from the external space 3. The light-transmitting panel 20 has a flat panel inner surface 22 that faces the internal space 13 and encloses the internal space 13 with the inner surface of the casing 10. The panel inner surface 22 functions as an exit surface for the target light image into the internal space 13.

The panel outer surface 21 is provided with a light-transmitting outer surface coating layer 210. The outer surface coating layer 210 may be formed of a dielectric film or a synthetic resin film that covers the base material of the light-transmitting panel 20. The outer surface coating layer 210 exhibits at least one type of film characteristics, such as antireflective properties, water repellency, weather resistance, heat resistance, band-pass filter performance, and infrared cut filter performance. It should be noted that the panel inner surface 22 of the light-transmitting panel 20 may be provided with a similar inner surface coating layer, or the inner surface coating layer may be omitted.

The camera unit 30 is disposed within the internal space 13 of the casing 10. The camera unit 30 includes a camera housing 31, a light-receiving lens system 32, and an imaging circuit system 33.

The camera housing 31 is formed in a hollow shape, smaller than the casing 10, and is mainly formed of multiple light-shielding base materials, such as synthetic resin or metal. The camera housing 31 is accommodated within the internal space 13 of the casing 10 and is held by the casing 10 via a bonding resin 310. The camera housing 31 has one end in the horizontal direction that defines a light-receiving opening 35. The light-receiving opening 35 passes through the camera housing 31 between the outer surface and the inner surface of the camera housing 31.

The light-receiving lens system 32 is configured by combining a lens barrel 36 and multiple optical components 37. The lens barrel 36 is formed in a cylindrical shape smaller than the casing 10, mainly using a light-shielding base material such as synthetic resin or metal. The lens barrel 36 is mounted to the light-receiving opening 35 of the camera housing 31, for example, via an adhesive. As a result, the lens barrel 36 is held by the casing 10 via the camera housing 31, in a state where the lens barrel 36 is accommodated within the internal space 13 of the casing 10, aligned in a horizontal direction substantially perpendicular to the vertical wall 14. The lens barrel 36 covers the light-receiving opening 35 to be capable of guiding a target optical image, which enters from the external space 3 through the light-transmitting panel 20 and the internal space 13, into the interior of the camera housing 31.

Each of the optical components 37 is formed in the required optical shape, mainly using a light-transmitting base material such as synthetic resin or glass. At least one of the optical components 37 is a lens component 370 formed in a lens shape that meets the required specifications. Each of the optical components 37 is fitted and mounted to the peripheral wall of the lens barrel 36, for example, via an adhesive. As a result, the optical components 37 are positioned inside the lens barrel 36 to have an optical axis Oa coaxially with the lens barrel 36, thereby enabling the optical image that has entered from the external space 3 through the light-transmitting panel 20 and the internal space 13 to form an image inside the camera housing 31.

The imaging circuit system 33 is configured by combining an imaging substrate 38 and multiple circuit components 39. The imaging substrate 38 is formed primarily from a rigid substrate such as a glass epoxy substrate, and is generally shaped as a flat plate. The imaging substrate 38 is held by the casing 10 via the camera housing 31 in a state where the imaging substrate 38 is positioned along the horizontal direction and the vertical direction, substantially perpendicular to the optical axis Oa, in the camera housing 31.

The circuit components 39 are mounted in a dispersed manner on the imaging substrate 38. Some of the circuit components 39 are mounted on a mounting surface 38a of the imaging substrate 38 facing the light-receiving opening 35, and the other of the circuit components 39 are mounted on a mounting surface 38b that is an opposite side of the mounting surface 38a. One of the circuit components 39 mounted on the mounting surface 38a of the imaging substrate 38 facing the light-receiving opening 35 may be an imaging element 390 such as a CCD or CMOS.

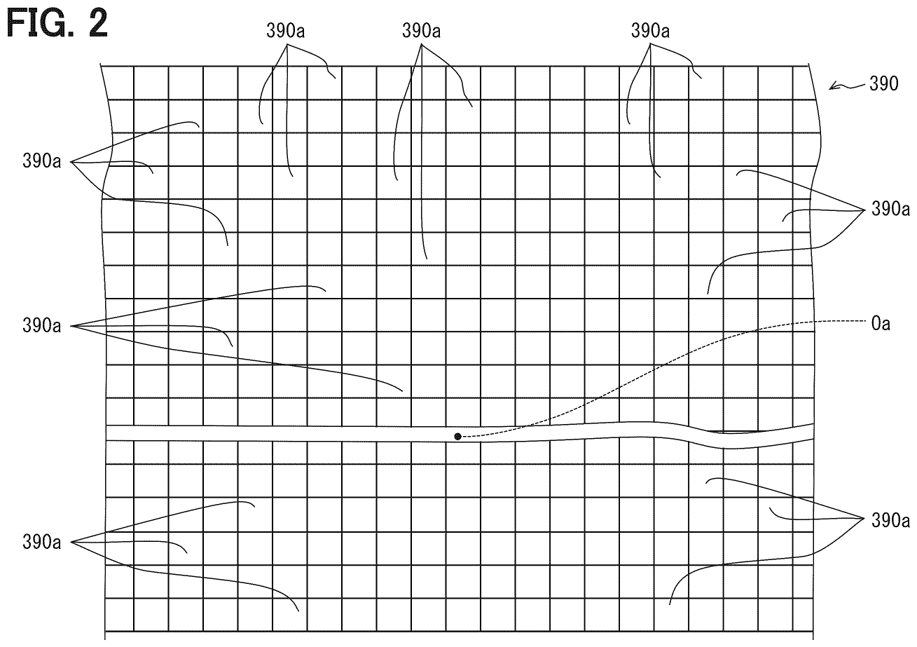

The imaging element 390 is aligned on the optical axis Oa provided by the light-receiving lens system 32 inside the camera housing 31. The imaging element 390 receives light from the external space 3 through the light-transmitting panel 20 and the internal space 13, and optically captures the target optical image formed by the light-receiving lens system 32. For this purpose, as shown in FIG. 2, the imaging element 390 includes multiple imaging pixels 390a, each of which outputs an imaging signal. The multiple imaging pixels 390a are two-dimensionally arranged along the horizontal direction and the vertical direction on a plane substantially orthogonal to the optical axis Oa.

Under such a configuration, the imaging circuit system 33 in FIG. 1 performs an imaging process for the external space 3 through the light-transmitting panel 20. In the imaging process the imaging circuit system 33 controls imaging of the target optical image by the imaging element 390. The imaging circuit system 33 generates image information based on the imaging signals from each imaging pixel 390a as imaging information. Furthermore, as part of the imaging process for the external space 3, the imaging circuit system 33 may generate imaging information including recognition information that identifies a target in the external space 3, by performing image processing based on the imaging signals.

The light source unit 40 includes a light source substrate 41 and an illumination light source 42. The light source substrate 41 is formed primarily from a rigid substrate such as a glass epoxy substrate, and is overall shaped as a flat plate. The light source substrate 41 is held by the casing 10 in a state where the light source substrate 41 is housed within the internal space 13 of the casing 10 but outside the camera unit 30. The light source substrate 41 is positioned offset from the optical axis Oa in a direction perpendicular to the optical axis Oa. The light source substrate 41 is inclined with respect to the optical axis Oa, so that a mounting surface 41a of the light source substrate 41 faces obliquely toward the panel inner surface 22 of the light-transmitting panel 20.

The illumination light source 42 is mounted on the mounting surface 41a of the light source substrate 41, and is held by the casing 10 via the light source substrate 41. As a result, the illumination light source 42 is positioned at a fixed light emission point Fp within the internal space 13 of the casing 10. Thus, within the internal space 13 where the illumination light source 42 is disposed, the imaging element 390 is positioned offset from the fixed light emission point Fp.

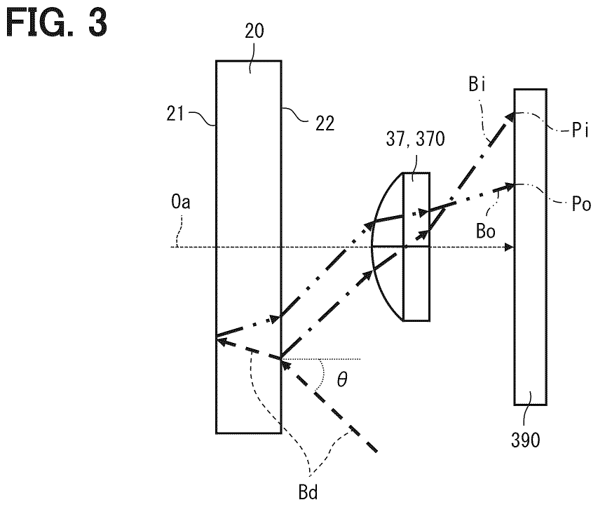

The illumination light source 42 is mainly formed of a light-emitting element, such as an LED (Light Emitting Diode) or a laser diode, which emits directional visible light. The illumination light emitted from the fixed light emission point Fp by the illumination light source 42 is obliquely incident on the panel inner surface 22 of the light-transmitting panel 20, as shown in FIG. 3, thereby forming a diagnostic beam Bd with a beam spot shape that is circular or elliptical. Here, the light source unit 40 may be additionally provided with optical components to collimate or otherwise shape the illumination light from the illumination light source 42 to form the diagnostic beam Bd. It should be noted that FIG. 3 is a schematic diagram in which, for ease of understanding, only one representative lens component 370 is shown as the optical component 37, and the imaging element 390 is illustrated in an enlarged manner compared to its actual size.

At the interface between the panel inner surface 22 of the light-transmitting panel 20 and the internal space 13, the diagnostic beam Bd is reflected. As a result, an internal reflection beam Bi is generated, which enters the interior of the lens barrel 36 and the camera housing 31 and is focused onto the imaging element 390. On the other hand, at the interface between the panel outer surface 21 of the light-transmitting panel 20 and the external space 3, the diagnostic beam Bd that has partially passed through the light-transmitting panel 20 from the panel inner surface 22 is reflected. As a result, an external reflection beam Bo is generated, which passes through the light-transmitting panel 20, then enters the interiors of the lens barrel 36 and the camera housing 31, and is focused onto the imaging element 390.

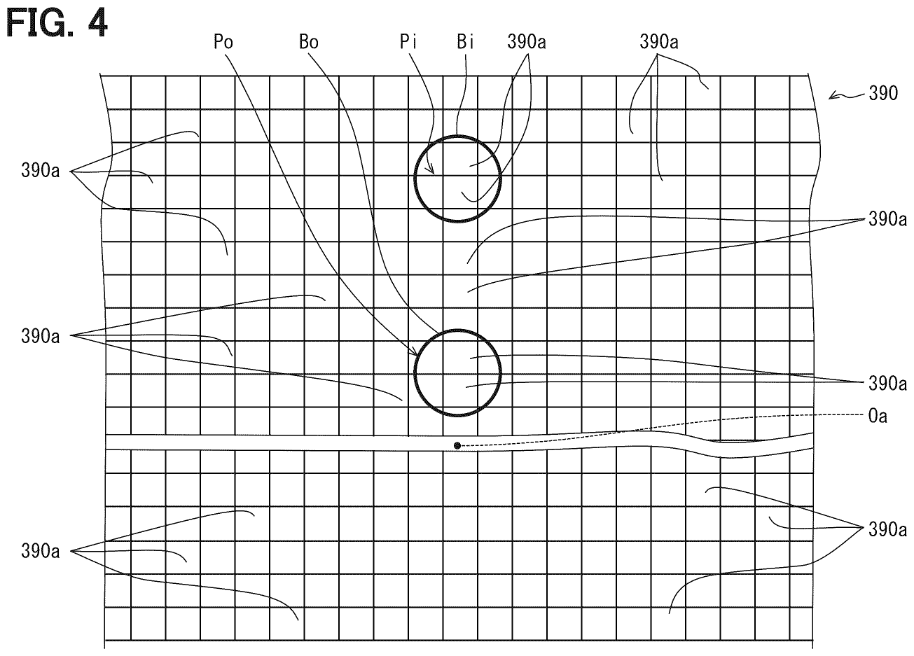

The internal reflection beam Bi and the external reflection beam Bo of the diagnostic beam Bd are adjusted so that their reflected optical paths, which are incident on the lens components 370 of the light-receiving lens system 32 and received by the imaging element 390, are different from each other. Accordingly, as shown in FIGS. 3 and 4, an internal reflection receiving position Pi, which is the array position of at least one imaging pixel 390a that receives the internal reflection beam Bi, and an external reflection receiving position Po, which is the array position of at least one imaging pixel 390a that receives the external reflection beam Bo, are offset from each other in a direction orthogonal to the optical axis Oa on the imaging element 390.

That is, on the imaging element 390, the imaging pixel 390a located at the internal reflection receiving position Pi, which receives the internal reflection beam Bi, and the imaging pixel 390a located at the external reflection receiving position Po, which receives the external reflection beam Bo, are different from each other. Thus, the dimensions of each component in the imaging device 1 are pre-designed so that the imaging pixel 390a at the internal reflection receiving position Pi and the imaging pixel 390a at the external reflection receiving position Po are separated from each other in a direction orthogonal to the optical axis Oa, with other imaging pixels 390a positioned between them. Here, in particular, it is preferable that in the imaging device 1, the incident angle θ (see FIG. 3) of the diagnostic beam Bd on the panel inner surface 22 is pre-designed, for example, based on the thickness and material of the light-transmitting panel 20.

The diagnostic device 100 shown in FIG. 1 is connected to the imaging element 390 and the illumination light source 42 via at least one type of connection, such as a LAN (Local Area Network), wire harness, or internal bus. The diagnostic device 100 is configured to include at least one dedicated computer. The dedicated computer constituting the diagnostic device 100 may be an imaging ECU (Electronic Control Unit) specialized for controlling the imaging device 1. In this case, the imaging ECU may be housed within the casing 10 or the camera housing 31 (as in the example of FIG. 1), as a component included in the imaging device 1. The dedicated computer constituting the diagnostic device 100 may be a driving control ECU for controlling the driving of the vehicle. In this case, although not shown in the figures, the driving ECU may be disposed inside the vehicle but outside the casing 10.

The dedicated computer constituting the diagnostic device 100 includes at least one memory 101 and at least one processor 102. The memory 101 is a non-transitory tangible storage medium that non-temporarily stores computer-readable programs and data, such as a semiconductor memory, magnetic medium, or optical medium. The processor 102 includes, as a core, at least one of a CPU (Central Processing Unit), GPU (Graphics Processing Unit), RISC (Reduced Instruction Set Computer) CPU, DFP (Data Flow Processor), and GSP (Graph Streaming Processor).

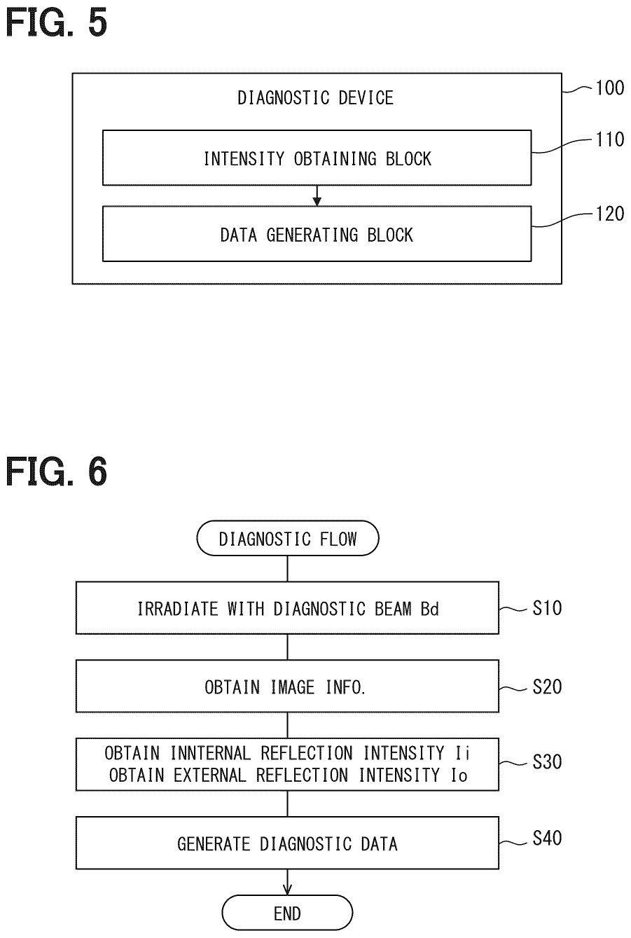

The processor 102 executes instructions included in a diagnostic program stored in the memory 101. As a result, the diagnostic device 100 constructs functional blocks for diagnosing the imaging device 1. The functional blocks constructed by the diagnostic device 100 include an intensity obtaining block 110 and a data generating block 120, as shown in FIG. 5.

Through the cooperation of these blocks 110 and 120, the diagnostic data generating method in which the diagnostic device 100 generates diagnostic data Dd by diagnosing the imaging device 1 is executed according to a diagnostic flow shown in FIG. 6. The diagnostic flow may be executed when the vehicle is started. Each “S” in the diagnostic flow represents steps executed by the instructions included in the diagnostic program.

In S10, the intensity obtaining block 110 controls the illumination light source 42 to emit light, thereby irradiating the light-transmitting panel 20 with the diagnostic beam Bd. In S20, in response to the irradiation, the intensity obtaining block 110 obtains imaging information from the imaging element 390, which has received the internal reflection beam Bi at the internal reflection receiving position Pi and the external reflection beam Bo at the external reflection receiving position Po. At this time, at least one type of imaging functions including auto exposure, auto white balance, gamma correction, and tone mapping, which would be enabled during normal imaging operations other than during execution of the diagnostic flow in the imaging device 1, may be changed. It is preferable that at least one of fixing the exposure (exposure time, gain), fixing the white balance, setting the gamma value to 1.0, or turning off tone mapping is implemented so that the imaging signal intensity output from the imaging element 390 changes proportionally to the input luminance value to the imaging element 390, through the change described above.

In S30, the intensity obtaining block 110 obtains the internal reflection intensity Ii, which is the reflection intensity at the panel inner surface 22, based on the imaging information representing the intensity of the imaging signal output from the imaging pixel 390a which is located at the internal reflection receiving position Pi (see FIGS. 3 and 4), as a result of receiving the internal reflection beam Bi. At this time, the internal reflection intensity Ii may be based on imaging information representing the imaging signal intensities from a predetermined number of imaging pixels 390a, which are located at the centroid position of the beam spot formed by the internal reflection beam Bi at the internal reflection receiving position Pi, or at an offset position within the beam spot that is offset by a set distance from the centroid position. The internal reflection intensity Ii thus obtained is stored in the memory 101.

At the same time, in S30, the intensity obtaining block 110 obtains the external reflection intensity Io, which is the reflection intensity at the panel outer surface 21, based on imaging information representing the intensity of the imaging signal output from the imaging pixel 390a, which is located at the external reflection receiving position Po (see FIGS. 3 and 4), as a result of receiving the external reflection beam Bo. At this time, the external reflection intensity Io may be based on imaging information representing the imaging signal intensities from a predetermined number of imaging pixels 390a, which are located at the centroid position of the beam spot formed by the external reflection beam Bo at the external reflection receiving position Po, or at an offset position within the beam spot that is offset by a set distance from the centroid position. The external reflection intensity Io thus obtained is also stored in the memory 101.

Furthermore, in S40, the data generating block 120 generates diagnostic data Dd indicating the deterioration state of the outer surface coating layer 210, as the condition of the panel outer surface 21 of the light-transmitting panel 20 where the outer surface coating layer 210 is provided. The deterioration state of the outer surface coating layer 210 is determined based on the relative intensity ratio IR between the internal reflection intensity Ii and the external reflection intensity Io obtained in S30. The relative intensity ratio IR is in accordance with the following equation 1.

$$IR = \frac{Ii \cdot Io \_ 0}{Io \cdot Ii \_ 0} \qquad ( Equation 1 )$$

Here, Ii_0 in Equation 1 refers to the initial intensity Ii_0, which serves as a standard intensity for the internal reflection intensity Ii. The initial intensity Ii_0 may be an intensity at the time of factory shipment of the imaging device 1. Io_0 in Equation 1 refers to the initial intensity Io_0, which serves as a standard intensity for the external reflection intensity Io. The initial intensity may be an intensity at the time of factory shipment of the imaging device 1.

In S40, the deterioration state of the outer surface coating layer 210 may be diagnosed from the relative intensity ratio IR between an inner reflection intensity Ii_n and an external reflection intensity Io_n. The internal reflection intensity Ii_n and the external reflection intensity Ii_n are calculated by normalizing the obtained values of the inner reflection intensity Ii and the external reflection intensity Io in S30 by their respective initial intensities Ii_0 and Io_0, as shown in the following equations 2 to 4 which are decomposed from Equation 1. Alternatively, as shown in the following Equations 5 to 7, which are decomposed from Equation 1 in a different form, in S40, the deterioration state of the outer surface coating layer 210 may be diagnosed based on the relative intensity ratio IR, which is obtained by normalizing the relative intensity ratio IR_g. The relative intensity ratio IR_g is calculated from the obtained values of the internal reflection intensity Ii and the external reflection intensity Io in S30. The relative intensity ratio IR is obtained by normalizing the relative intensity ration IR_g with an initial reference ratio IR_0. Here, the initial reference ratio IR_0, as represented by Equation 7, refers to the relative intensity ratio between the initial internal reflection intensity Ii_0 and the initial external reflection intensity Io_0.

$$IR = \frac{Ii \_ n}{Io \_ n} \qquad ( Equation 2 )$$

$$Io \_ n = \frac{Ii}{Ii \_ 0} \qquad ( Equation 3 )$$

$$Io \_ n = \frac{Io}{Io \_ 0} \qquad ( Equation 4 )$$

$$IR = \frac{IR \_ g}{IR \_ 0} \qquad ( Equation 5 )$$

$$IR \_ g = \frac{Ii}{Io} \qquad ( Equation 6 )$$

$$IR \_ 0 = \frac{Ii \_ 0}{Io \_ 0} \qquad ( Equation 7 )$$

In the diagnosis in S40, diagnostic data Dd that indicates deterioration state of the outer surface coating layer 210 that requires maintenance may be generated when the variation amount of the relative intensity ratio IR toward the decrease in the internal reflection intensity Ii increases beyond the allowable range (i.e., equal to or greater than the threshold). Alternatively, in the diagnosis of S40, diagnostic data Dd indicating that the degree of deterioration of the outer surface coating layer 210 has progressed may be generated as the relative intensity ratio IR changes toward the decrease in the internal reflection intensity Ii. In the latter case, the relative intensity ratio IR itself may be included in the diagnostic data Dd as an indicator representing the deterioration state.

In S40, the data generating block 120 may control a storage so that the generated diagnostic data Dd is stored in the memory 101 or in a data logger of the vehicle. In S40, the data generating block 120 may control the display so that the generated diagnostic data Dd is displayed by a display unit in the vehicle. In S40, the data generating block 120 may control transmission so that the generated diagnostic data Dd is transmitted to the outside via a communication device in the vehicle. In S40, the diagnostic data Dd may be output by means other than these storage, display, and transmission. As described above, upon completion of the execution of S40, the current execution of the diagnostic flow is ended.

(Operational Effects) The operational effects of the present embodiment described above will be explained below.

In the present embodiment, as a reflected beam corresponding to the diagnostic beam Bd emitted from the fixed light emission point Fp in the internal space 13, the internal reflection beam Bi at the panel inner surface 22 of the light-transmitting panel 20 is received by the imaging element 390 at the internal reflection receiving position Pi, thereby the internal reflection intensity Ii at the panel inner surface 22 is obtained. Along with this, as a reflected beam corresponding to the diagnostic beam Bd emitted from the fixed light emission point Fp, the external reflection beam Bo at the panel outer surface 21 of the light-transmitting panel 20 is received by the imaging element 390 at the external reflection receiving position Po, thereby the external reflection intensity Io at the panel outer surface 21 is obtained.

Accordingly, in the present embodiment, the diagnostic data Dd is generated so as to represent the deterioration state of the panel outer surface 21, where the light-transmitting outer surface coating layer 210 is provided, based on the relative intensity ratio IR between the internal reflection intensity Ii and the external reflection intensity Io. According to this, even if deterioration occurs in the outer surface coating layer 210 of the panel outer surface 21 in the external space 3, the fluctuation in the external reflection intensity Io caused by the deterioration of the outer surface coating layer 210 can be reflected in the relative intensity ratio IR, since deterioration of the panel inner surface 22 is suppressed within the internal space 13 and the internal reflection intensity Ii is less likely to fluctuate. Additionally, fluctuations in the intensity of the diagnostic beam Bd itself can be canceled out in the relative intensity ratio IR. From these considerations, it is possible to diagnose a decrease in imaging accuracy of the imaging device 1 due to deterioration of the outer surface coating layer 210, based on the deterioration state indicated by the diagnostic data Dd.

According to the present embodiment, when the imaging element 390 is positioned in the internal space 13 offset from the fixed light emission point Fp, the internal reflection beam Bi and the external reflection beam Bo are received by different imaging pixels 390a located at the internal reflection receiving position Pi and the external reflection receiving position Po, respectively. Accordingly, the internal reflection beam Bi and the external reflection beam Bo, which have different reflection optical paths with respect to the diagnostic beam Bd emitted from the fixed light emission point Fp, can be distinguished based on the differences in the imaging pixels 390a of the imaging element 390, which are offset from the fixed light emission point Fp, that receive these beams. As a result, each of the reflection intensities Ii and Io can be identified. Thus, it becomes possible to generate diagnostic data Dd that accurately reflects the deterioration state, based on the relative intensity ratio IR between the internal reflection intensity Ii and the external reflection intensity Io. Thus, the reliability of diagnosing a decrease in imaging accuracy of the imaging device 1 due to deterioration of the outer surface coating layer 210 can be enhanced.

According to the present embodiment, the diagnostic data Dd may be generated so as to represent the deterioration state based on the relative intensity ratio IR, which is obtained by normalizing the internal reflection intensity Ii and the external reflection intensity Io with their respective reference initial intensities Ii_0 and Io_0. Accordingly, even if the panel inner surface 22 deteriorates in the internal space 13, it is possible to offset the influence of such deterioration on the relative intensity ratio IR. Thus, it becomes possible to generate diagnostic data Dd that accurately represents the deterioration state based on the relative intensity ratio IR between the internal reflection intensity Ii and the external reflection intensity Io. Thus, the reliability of diagnosing a decrease in imaging accuracy of the imaging device 1 due to deterioration of the outer surface coating layer 210 is improved.

According to the present embodiment, the diagnostic data Dd may be generated so as to represent the deterioration state based on the relative intensity ratio IR normalized by the reference initial ratio IR_0. Accordingly, even if the panel inner surface 22 deteriorates in the internal space 13, it is possible to offset the influence of such deterioration on the relative intensity ratio IR. Thus, it becomes possible to generate diagnostic data Dd that accurately represents the deterioration state based on the relative intensity ratio IR between the internal reflection intensity Ii and the external reflection intensity Io. Thus, the reliability of diagnosing a decrease in imaging accuracy of the imaging device 1 due to deterioration of the outer surface coating layer 210 is improved.

(Other Embodiments) The above describes one embodiment, however, the present disclosure is not to be construed as being limited to the described embodiment, and can be applied to various embodiments without departing from the spirit and scope of the present disclosure.

In a variation, the dedicated computer constituting the diagnostic device 100 may include at least one of a digital circuit and an analog circuit as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such a digital circuit may also include a memory that stores a program.

In a variation, the mobile body to which the diagnostic device 100 and the imaging device 1 are applied may be an autonomous mobile robot capable of tasks such as cargo transport or information collection via autonomous driving or remote operation. In addition to the embodiments described so far, the above embodiments and variations may also be implemented, in the form of a semiconductor device (for example, a semiconductor chip), as a control device that is configured to be mountable on the applicable mobile body and includes at least one processor 102 and at least one memory 101.

1. A diagnostic device configured to diagnose an imaging device disposed in an internal space that is separated from an external space by a light-transmitting panel, the imaging device optically imaging the external space with an imaging element through the light-transmitting panel, the diagnostic device comprising
at least one processor configured to cause the diagnostic device to:
obtain an internal reflection intensity by receiving an internal reflection beam with the imaging element at an internal reflection receiving position, the internal reflection beam being a reflection of a diagnostic beam, which is emitted from a fixed point in the internal space, reflected on an inner surface of the light-transmitting panel that faces the internal space;
obtain an external reflection intensity by receiving an external reflection beam with the imaging element at an external reflection receiving position, the external reflection beam being a reflection of the diagnostic beam reflected on an outer surface of the light-transmitting panel that faces the external space; and
generate diagnostic data indicating a degradation state of the outer surface on which a light-transmitting coating layer is disposed, the degradation state being determined based on a relative intensity ratio between the internal reflection intensity and the external reflection intensity.

2. The diagnostic device according to claim 1, wherein
the imaging element is positioned in the internal space offset from the fixed point,
the imaging element includes at least two imaging pixels that are different from each other and positioned at the internal reflection receiving position and the external reflection receiving position, respectively, and
the processor is configured to receive the internal reflection beam and the external reflection beam with the at least two imaging pixels to obtain the internal reflection intensity and the external reflection intensity.

3. The diagnostic device according to claim 1, wherein
the degradation state is determined based on the relative intensity ratio between the internal reflection intensity and the external reflection intensity each of which is normalized using respective initial intensities as standards.

4. The diagnostic device according to claim 1, wherein
the degradation state is determined based on the relative intensity ratio that is normalized by an initial relative intensity as a standard.

5. The diagnostic device according to claim 1, wherein
the at least one processor is configured to control a storage of the generated diagnostic data.

6. The diagnostic device according to claim 1, wherein
the at least one processor is configured to control a display of the generated diagnostic data.

7. The diagnostic device according to claim 1, wherein
the at least one processor is configured to control a transmission of the generated diagnostic data.

8. An imaging device configured to image an external space with an imaging element from an internal space through a light-transmitting element that separates the internal space from the external space, the imaging device comprising:
the imaging element;
a light source configured to emit a diagnostic beam from a fixed point in the internal space; and
the diagnostic device according to claim 1.

9. A diagnostic data generating method executed by a processor to generate diagnostic data indicating a diagnosis of an imaging device, the imaging device optically imaging an external space from an internal space with an imaging element through a light-transmitting panel that separates the internal space from the external space, the diagnostic data generating method comprising:
obtaining an internal reflection intensity by receiving an internal reflection beam with the imaging element at an internal reflection receiving position, the internal reflection beam being a reflection of a diagnostic beam, which is emitted from a fixed point in the internal space, reflected on an inner surface of the light-transmitting panel that faces the internal space;
obtaining an external reflection intensity by receiving an external reflection beam with the imaging element at an external reflection receiving position, the external reflection beam being a reflection of the diagnostic beam reflected on an outer surface of the light-transmitting panel that faces the external space; and
generating the diagnostic data indicating a degradation state of the outer surface on which a light-transmitting coating layer is disposed, the degradation state being determined based on a relative intensity ratio between the internal reflection intensity and the external reflection intensity.

10. A non-transitory computer readable storage medium storing a diagnostic program to diagnose an imaging device that optically images an external space from an internal space with an imaging element through a light-transmitting panel that separates the internal space from the external space, the diagnostic program comprising instructions configured to, when executed by a processor, cause the processor to:
obtain an internal reflection intensity by receiving an internal reflection beam with the imaging element at an internal reflection receiving position, the internal reflection beam being a reflection of a diagnostic beam, which is emitted from a fixed point in the internal space, reflected on an inner surface of the light-transmitting panel that faces the internal space;
obtain an external reflection intensity by receiving an external reflection beam with the imaging element at an external reflection receiving position, the external reflection beam being a reflection of the diagnostic beam reflected on an outer surface of the light-transmitting panel that faces the external space; and
generate diagnostic data indicating a degradation state of the outer surface on which a light-transmitting coating layer is disposed, the degradation state being determined based on a relative intensity ratio between the internal reflection intensity and the external reflection intensity.
